(19) United States
(12) Patent Application Publication
(10) Pub. No.: US 2026/0035181 A1
(43) Pub. Date: Feb. 5, 2026

(54) CONVEYING DEVICE FOR CONVEYING MATERIAL

(71) Applicant: ONEJOON GMBH, Bovenden (DE)

(72) Inventors: Petrus Jacobus Vervoort, Bovenden (DE); Christoph Redeker, Kalefeld (DE); Matthias Muck, Adelebsen (DE)

(21) Appl. No.: 18/994,788

(22) PCT Filed: Jun. 30, 2023
(86) PCT No.: PCT/EP2023/068061

§ 371 Date: Jan. 15, 2025

(30) Foreign Application Priority Data
Jul. 20, 2022 (DE) 10 2022 118 110.3

(51) Int. Cl. B65G 33/14; B65G 33/26

(52) U.S. Cl. CPC B65G 33/14; B65G 33/26; B65G 2201/042; B65G 2812/0511; B65G 2812/0577

(57) ABSTRACT

A conveying device for conveying material, in particular material having a temperature of 1500° C. to 3200° C., in particular for conveying thermally or thermo-chemically treated material, has a housing which has a material inlet and a material outlet. The material can be conveyed from the material inlet to the material outlet along a conveying path by means of a conveying device. Along the conveying path, such surfaces that come into contact with the material to be conveyed are provided, at least in certain areas, by a material that is a graphite material or a material with graphite-like properties.

### BACKGROUND OF THE INVENTION

### 1. Field of the Invention

The invention relates to a conveying device for conveying material, in particular material with a temperature of 1,500° C. to 3,200° C., in particular for conveying thermally or thermo-chemically treated material, with
a) a housing having a material inlet and a material outlet;
b) a conveying device by means of which the material can be conveyed from the material inlet to the material outlet along a conveyance path.

### 2. Description of the Prior Art

The invention is described herein based on the graphitization of graphitizable material in an inert gas atmosphere. It is known to produce polycrystalline graphite, which is used for anode material, in batch processes in so-called Acheson furnaces, in which graphitizable material is graphitized to graphite.

From DE 10 2019 126 394 A1, it is known to carry out the graphitization of graphitizable material in a continuous, self-contained process in which the material is passed through a stationary process housing. A conveying device of the type mentioned at the outset operates at the inlet and outlet of the process housing.

In particular, at the outlet of the process housing, where the graphite obtained at a temperature of more than 1,500° C. must be removed evenly over the entire cross-sectional area, cooled quickly, and conveyed, the conveying device there wears out and contaminates the material with foreign substances and must be replaced after some time; the service life of the conveying device is therefore usually limited.

To replace the conveying device, the system must be shut down and cooled down and then restarted and heated up again after the conveying device has been replaced. Apart from the energy expenditure involved, there is also always a loss of material.

Previously, the cooling of the graphitizable, generally powdery material has been performed in a long, externally water-cooled channel in which the material stands as a powder column. Cooling occurs purely through heat conduction from the inside of the powder column to the outside into the water-cooled casing of the channel. At the end of the channel, the then-colder material is discharged via a connected conveying device. The water-cooled channel is very long due to the poor thermal conductivity of the material and the resulting long residence time.

### SUMMARY OF THE INVENTION

It is an object of the present invention to provide a conveying device of the type mentioned at the outset which makes a longer service life possible and takes this idea into account. In particular, it should be possible to discharge the material evenly and without causing ratholing or arching, as is generally known to occur with bulk materials, to cool the material as quickly as possible from the high outlet temperature at the exit of the process housing, in particular from temperatures greater than 1,500° C. to temperatures below 100° C., and also not to contaminate the material.

This object is achieved in a device of the type mentioned at the outset in that,
c) along the conveyance path, those surfaces which come into contact with the material that is to be conveyed are at least partially provided by a material which is a graphite material or a material with graphite-like properties.

According to the invention, it was recognized that although the processing of such materials can increase the costs for the manufacture of a conveying device, the overall balance of their use is nevertheless positive, since costly downtimes of a system are reduced when a conveying device according to the invention is used.

In this context, graphite-like materials are understood to mean in particular materials having melting points similar to that of graphite, in any case with melting points substantially above 3,000° C.

It is advantageous if all surfaces which come into contact with the material that is to be conveyed along the conveyance path are provided by the material.

The material can be preferably hard graphite and/or a CFC material and/or a carbide material. The “and/or” wording is intended here to express that different surfaces can also be provided by different materials.

It is advantageous if the conveyance path comprises a conveying chamber which defines a longitudinal axis and in which a conveying element is arranged; such a conveying element can be readily manufactured from the material.

This is particularly possible with a first alternative in which the conveying element is a screw conveyor which is arranged parallel to the longitudinal axis of the conveying chamber and has a threaded web, thereby forming a conveyance path.

Advantageously, the screw conveyor has one or more or all of the following parameters:
a) a web width at the passage inlet of 10 mm to 50 mm, in particular 20 mm to 30 mm;
b) a web width at the passage base of from 20 mm to 100 mm, in particular from 40 mm to 60 mm;
c) a passage depth of from 2 mm to 30 mm, in particular from 10 mm to 20 mm;
d) a passage width at the passage base of from 10 mm to 50 mm, in particular from 25 mm to 40 mm;
e) a core diameter of from 50 mm to 300 mm, in particular from 80 mm to 100 mm.

It should be emphasized that the conveying device should cool the material that is to be conveyed particularly when it is used as a discharge conveyor. By adjusting these parameters, a small passage depth can be taken into account, so that only a thin layer of material can be taken up by the screw conveyor in the radial direction. A commensurately thin layer can cool down proportionately faster than a thicker layer.

In a preferred alternative, the conveying element is a conveying roller which has conveying grooves on its outer lateral surface running in particular parallel to the longitudinal axis of the conveying chamber.

Advantageously, such a conveyor roller has one or more or all of the following parameters:
a) a groove width at the groove inlet of from 10 mm to 100 mm, in particular from 15 mm to 25 mm;
b) a groove width at the groove base of from 5 mm to 95 mm, in particular from 10 mm to 20 mm;
c) a groove depth of from 2 mm to 30 mm, in particular from 3 mm to 10 mm;
d) a spacing of the conveying grooves in the circumferential direction of from 5 mm to 30 mm, in particular from 10 mm to 20 mm;
e) a core diameter of from 50 mm to 1000 mm, in particular from 80 mm to 200 mm.

What was said above regarding the layer thickness of the taken-up material applies here accordingly to the conveying grooves and the groove depth thereof.

Preferably, the conveying chamber is delimited by the inner circumferential surface of a protective casing made of the material.

To simplify the assembly of the conveying device, it can be advantageous if the protective casing is made up of multiple parts.

The cooling of the material during conveyance is effectively supported if a cooling system is available by means of which the conveying element and/or the protective casing can be cooled. The contact of the material with the surfaces thereof results in constant cooling thereof.

It is structurally advantageous if the cooling system comprises one or more coaxial cooling pipes which are respectively arranged in the conveying element and/or in the protective casing.

In particular, the conveying element can be effectively cooled by arranging a coaxial cooling pipe coaxially with the longitudinal axis of the conveying element.

A compact option for connecting the conveying device to required sources and circuits for cooling media is possible if connection units of the existing coaxial cooling pipes are accessible from the outside at a connection terminal of the conveying device. There, the connection units of the coaxial cooling pipes are located spatially close to one another.

In order to achieve the greatest possible cooling effect or an effective temperature transfer, it is advantageous for the conveying element to be made entirely of the material, in particular hard graphite, CFC material, or carbide material.

The conveying device can be used in an especially flexible manner if the housing has a first passage, a second passage, and a third passage, of which only a first passage provides the material inlet and only a second passage provides the material outlet, depending on the conveying element. The remaining third passage remains unused and can be sealed if necessary. In this way, the position of the material inlet or outlet can also be optionally adapted to changing conditions.

### BRIEF DESCRIPTION OF THE DRAWINGS

In the following, exemplary embodiments of the invention are explained in greater detail with reference to the drawings, in which:

FIG. 1 shows a section of a first exemplary embodiment of a device for the thermal or thermo-chemical treatment of material in which a process housing is constructed from housing segments;

FIG. 2 shows a section of a second exemplary embodiment of such a device;

FIGS. 3a and 3b show five phases A, B, C, D, and E of a cycle for exchanging housing segments in the device according to the first exemplary embodiment;

FIGS. 4a and 4b show five phases A, B, C, D, and E of a cycle for exchanging housing segments in the device according to the second exemplary embodiment;

FIG. 5 is a perspective view of a conveying device used in the device according to the first exemplary embodiment;

FIG. 6 is a side view of the conveying device;

FIG. 7 is a front-side view of the conveying device

FIGS. 8 to 10 show sections of the conveying device according to the sectional lines VIII-VIII, IX-IX, and XX of FIGS. 5 to 7 and IX-IX of FIG. 10, respectively;

FIGS. 11 to 13 show sections of a second exemplary embodiment of the conveying device according to the sectional lines XI-XI, XII-XII, and XIII-XIII of FIGS. 5 to 7 and XII-XII of FIG. 13, respectively.

### DESCRIPTION OF PREFERRED EXEMPLARY EMBODIMENTS

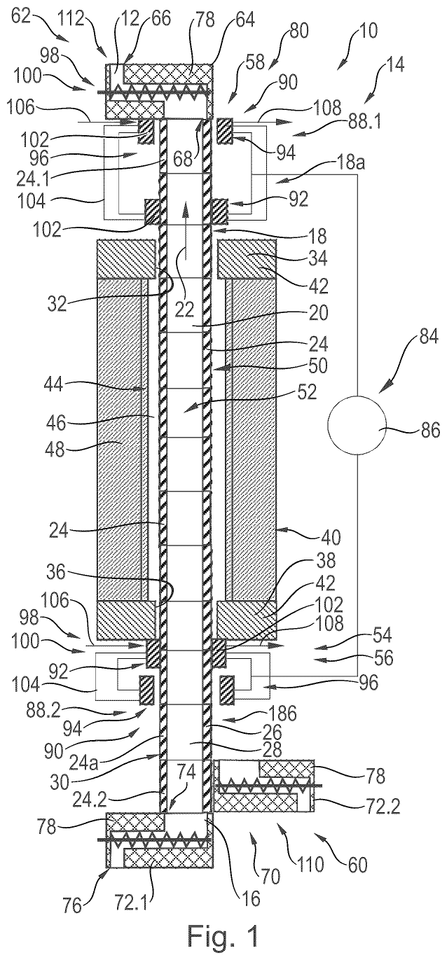

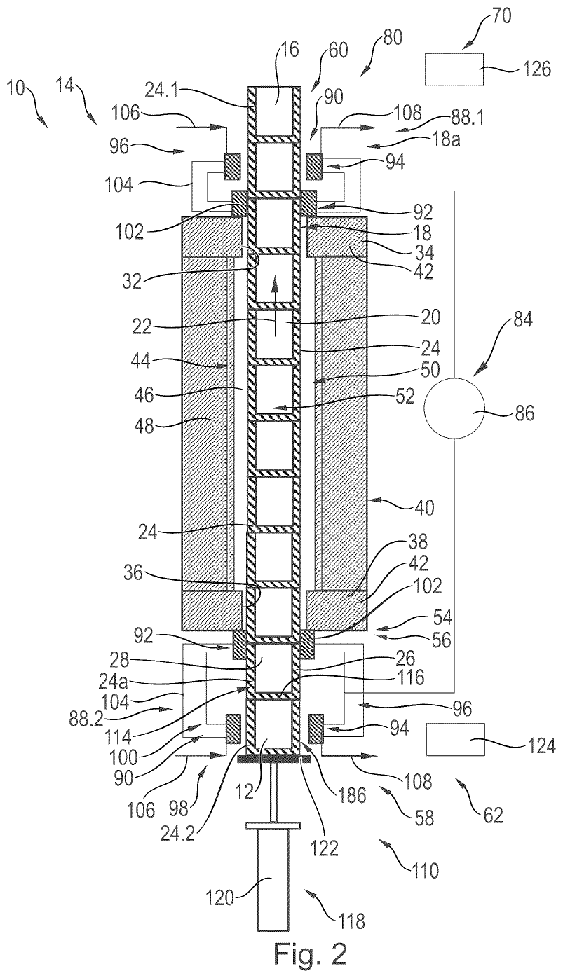

FIGS. 1 and 2 show a first and a second exemplary embodiment of a device 10 for the thermal or thermo-chemical treatment of material 12.

In the present case, the device 10 is described using the example of a vertical graphitization furnace 14, which is used to produce graphite 16, here polycrystalline, for anode material and will be referred to hereinafter simply as the furnace 14. However, everything said in this regard also applies generally or analogously to the device 10, without this necessarily having to be linked to the graphitization of material 12.

Particulate graphitizable material is used as the material 12, i.e., the starting material which is treated in the graphitization furnace 14. Graphitizable materials contain carbon, with graphitization resulting in a conversion of amorphous carbon to polycrystalline graphite. The most prominent examples of graphitizable materials include needle coke, petroleum coke, natural graphite, lignite, or hard coal, and possibly also plastics.

To begin with, reference is now made to FIG. 1, which shows a first exemplary embodiment of the device 10.

The furnace 14 comprises a process housing 18 which defines a process chamber 20. The process chamber 20 defines a process chamber axis 22, which establishes an axial process chamber direction which is indicated by an arrow. In the vertical furnace 14 under discussion here, the process chamber axis 22 runs vertically.

The process housing 18 is constructed from housing segments 24 which are detachably attached to one another and only some of which bear a reference numeral. The housing segments 24 are placed together along the process chamber axis 22. The housing segments 24 are made of graphite.

As illustrated by a housing segment 24 denoted by 24a, each housing segment 24 has a circumferential housing shell wall 26 and delimits a process chamber section 28 which is open on both opposite end sides of the housing segment 24. In practice, the process chamber section 28 has a constant circular cross section, which then also applies to the process chamber 20.

However, in the case of refinements which are not specifically shown, other cross sections may also be provided, in particular elliptical, rectangular, and especially square cross sections. As a rule, the cross-sectional outer contour of a housing segment 24 follows the geometry of the inner cross section of the process chamber section 28, but it may also deviate therefrom. For example, a process chamber section 28 with a circular cross section can be formed in a housing segment 24 with an outer contour that is square in cross section.

In the first exemplary embodiment according to FIG. 1, each housing segment 24 is embodied as a housing sleeve 30 whose housing shell wall 26 describes a hollow cylinder, i.e., a hollow circular cylinder, and is open on both end faces. For the sake of clarity, reference numeral 30 is also only given in the housing segment 24a.

In practice, such a housing sleeve 30 can have a wall thickness of between 7 mm and 18 mm and an outer diameter of between 120 mm and 240 mm. Specifically, for example, a wall thickness of mm with an outer diameter of 120 mm or 180 mm and a wall thickness of 15 mm with an outer diameter of 240 mm can be implemented. The axial extent of the housing sleeve 30 can be up to 1600 mm. However, the relations of wall thickness, diameter, and axial extent can also deviate from this.

FIG. 1 illustrates the conditions for housing sleeves 30 with correspondingly shorter axial extent.

The process housing 18 extends through a passage opening 32 of an upper, top wall 34 and through a passage opening 36 of a lower bottom wall 38 of an insulation housing 40 made, for example, of sheet steel, so that the process housing 18 protrudes upward from the insulation housing 40 with an upper end section 18a and downward with a lower end section 18b. Annular insulation elements 42, preferably made of graphite hard felt, are provided on the top wall 34 and the bottom wall 38 of the insulation housing 40.

The passage openings 32 and 36 of the top wall 34 and the bottom wall 38 are flow-tight against the outside environment, which is not specifically shown here.

A protective housing 44 made of graphite, for example a protective tube, for the process housing 18 extends from the top wall 34 to the bottom wall 38 of the insulation housing 40 in such a way that an annular space 46 is formed between the process housing 18 and the protective housing 44 which is open at the top and bottom to the passage openings 32 and 36 of the top wall 34 and the bottom wall 38, respectively.

In refinements that are not specifically shown, multiple protective housings can also be present, or one protective housing can accommodate multiple process housings 18, enabling multiple process housings 18 to be operated in parallel.

Radially to the outside next to the protective housing 44, an insulation annular space 48 is formed which is delimited by the protective housing 44, the insulation housing 40, and the insulation elements 42. In the present exemplary embodiment, this insulation annular space 48 is filled with soot.

In the device 10, there is a core process section 50 in which the process housing 18 defines a core process chamber 52.

In the present exemplary embodiment, that portion of the process housing 18 which is radially surrounded by the protective housing 44 defines the core process section 50 of the device 10, with the associated portion of the process chamber 20 corresponding in this core process section 50 to the core process chamber 52. Independently of the protective housing 44, the core process section 50 is arranged between the two end sections 18a and 18b of the process housing 18.

With the aid of a protective gas system 54, a protective gas is caused to flow through the annular space 46, which surrounds the process chamber housing 18, and the insulation annular space 48. The protective gas is necessary, since the graphitization of the graphitizable material 12 takes place in an inert gas atmosphere which is present in the process chamber 20. As a rule, the same gas as the inert gas is used as the protective gas, so that the same type of gas is present on both sides of the process chamber housing 18. However, different gases can also be used as protective gas and as inert gas, in which case the protective gas must also be inert. Argon, nitrogen, or helium or a mixture thereof can be used as a protective gas and/or as an inert gas.

For this purpose, the protective gas system 54 comprises protective gas inlet connections (not specifically shown) at the upper and lower ends of the insulation housing and one or more protective gas outlet connections, enabling protective gas to flow continuously through the annular spaces and be discharged as exhaust gas. For the sake of simplicity, conveying components required for conveying protective gas, inert gas, or exhaust gas, such as blowers, gas pumps, and the like, and associated lines and control devices as well, are not specifically shown.

In addition, a housing cooling device, denoted only generally by 56, for protecting the housing components is present which is embodied in an inherently known manner as a water cooling system.

The device 10 has an inlet zone 58 and an outlet zone 60, and in the present exemplary embodiment the inlet zone 58 is arranged vertically above and the outlet zone 60 is arranged vertically below.

In the inlet zone 58, the terminal housing segment 24 defines an inlet housing segment 24.1 of the process housing 18. In the outlet zone 60, the terminal housing segment 24 defines an outlet housing segment 24.2

In the present exemplary embodiment, the inlet housing segment 24.1 is connectable or connected to a supply device 62 for the graphitizable material 12. In the present exemplary embodiment, this supply device 62 comprises a feed conveyor 64 whose inlet side 66 is fed with the material 12 from a material reservoir (not specifically shown) and whose outlet side 68 is connected to the inlet housing segment 24.1. The inlet housing segment 24.1 is the vertically uppermost segment of the housing segments 24 of the process housing 18.

The outlet housing segment 24.2 of the process housing 18 in the outlet zone 60 is connected to a delivery device 70, with which the manufactured material—here the polycrystalline graphite 16—is discharged from the process housing 18. In the present exemplary embodiment, the delivery device 70 comprises a first discharge conveyor 72.1 and a second discharge conveyor 72.2, which can be alternately coupled to the outlet housing segment 24.2. The two discharge conveyors 72.1, 72.2 are operated alternately; this will be discussed in greater detail below. In the configuration shown in FIG. 1, the outlet housing segment 24.2 is connected to the inlet side 74 of the first discharge conveyor 72.1. An outlet side 76 of the discharge conveyor 72 discharges the material 16. In this configuration, the outlet housing segment 24.2 is the vertically lowermost housing segment 24 of the process housing 18.

The vertical extent of the discharge conveyor 72.1, 72.2 is equal to or less than the vertical extent of the housing segments 24.

To put it generally, the device 10 comprises a conveyor system 80 which is designed to convey the material 12 through the core process section 50.

In the present exemplary embodiment, this conveyor system 80 comprises the supply device 62, here with the feed conveyor 64, and the delivery device 70, here with the discharge conveyors 72.1, 72.2.

The feed conveyor 64 and the two discharge conveyors 72.1, 72.2 are designed in such a way that a gas-tight connection to the process housing 18 can be formed and the conveyance can also take place with the exclusion of the ambient atmosphere.

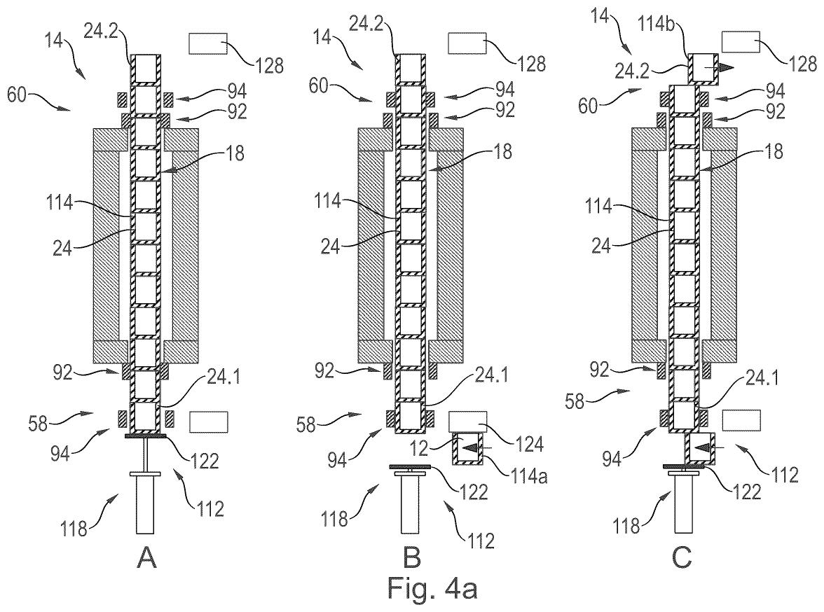

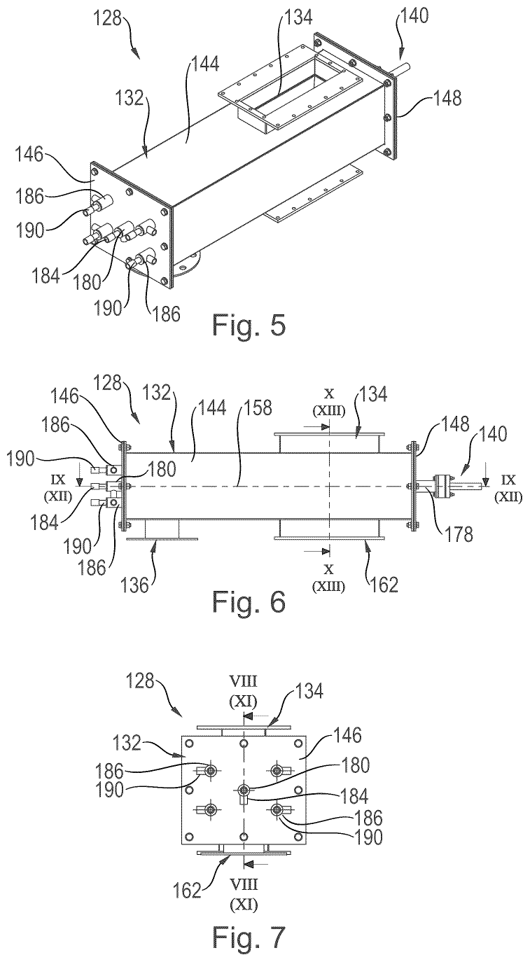

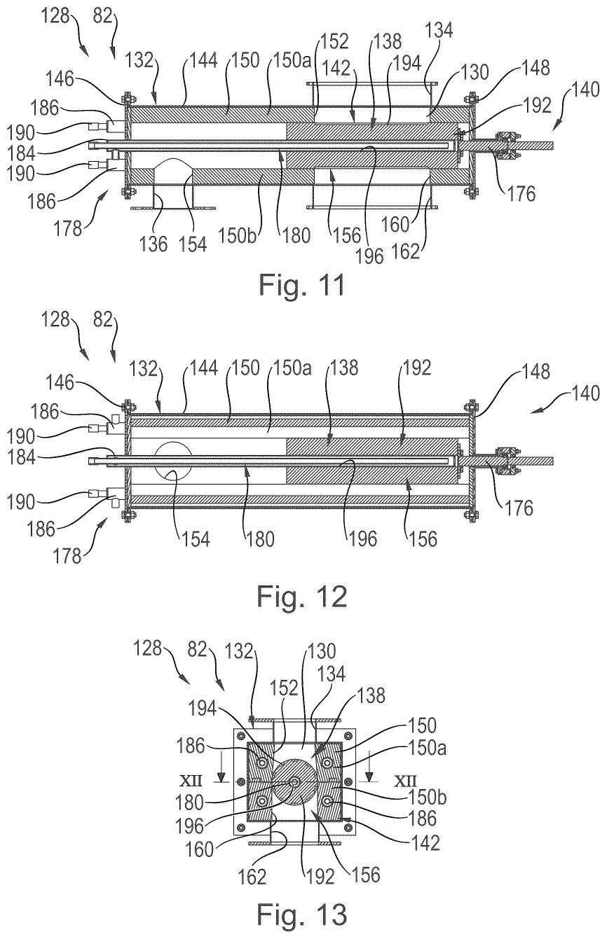

FIG. 1 illustrates the feed conveyor 64 and the discharge conveyors 72.1, 72.2 as screw conveyors 78, which will be discussed again below with reference to FIGS. 5 to 10. FIGS. 11 to 13, which will also be discussed below, show a roller conveyor 82 as an alternative. Other conveyance concepts, such as rotary valves, double flap systems in conjunction, for example, with a conveyor belt or a vibrating trough or the like, also merit consideration.

As mentioned above, an inert gas atmosphere exists in the process chamber 20. The inert gas is supplied to the process chamber 20 by means of the delivery device 70 at the bottom via the outlet zone 60 and is extracted at the top via the inlet zone 56 by means of the supply device 62, so that the material guided from top to bottom through the process chamber 20 is flowed through in countercurrent by inert gas.

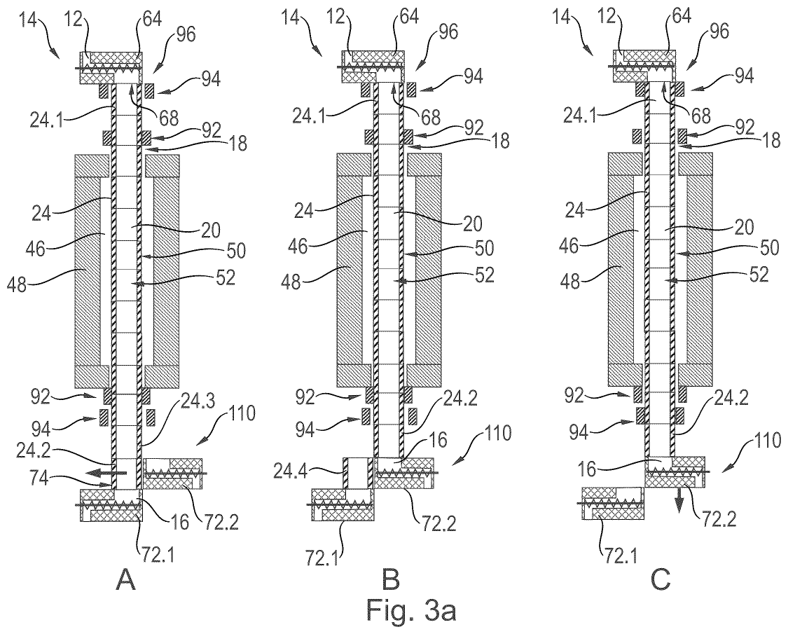

For the sake of simplicity, appropriate inert gas connections at the dispensing device 70 and the supply device 62 are not shown in FIGS. 1, 3a, and 3b.

With the aid of a heating device 84, the process chamber 20 is heated, at least in the core process chamber 52, to between approximately 2,200° C. and approximately 3,200° C., preferably to approximately 3,000° C., for the graphitization process. The heating device 84 is used to heat the process housing 18 and, in the present exemplary embodiment, the housing segments 24. For this purpose, the process housing 18 is supplied with electrical voltage from a power source 86.

A first contact region 88.1 is provided for this purpose at the upper end section 18a of the process housing 18, and a second contact region 88.2 is provided at the lower end section 18b of the process housing 18 for the electrical contacting of the process housing 18. Generally speaking, the contact regions 88.1, 88.2 are arranged outside the core process section 50. Electrical contacts 90 are present in these contact regions 88.1 and 88.2 which are connected to the power source 86 via electrical lines, which are not separately denoted.

Generally speaking, the heating device 84 is set up so as to enable the process housing 18 as such to be heated. The way this this achieved is that the process housing 18 can be heated by heating contacts 90 which are able to contact the process housing 18 immediately and directly. This means that the energy supply is applied directly to the process housing 18 and that the latter is not heated indirectly by heat transfer.

To support this heating of the process housing 18 as such, a secondary or auxiliary heating device can be provided in a refinement that is not specifically shown. For example, a heating tube or heating housing which is made of graphite and is permanently heated electrically can be arranged between the process housing 18 and the protective housing 44.

In the exemplary embodiment described here, the area between the top wall 34 of the insulation housing 40 and the supply device 62 defines the first contact region 88.1, and the area between the bottom wall 38 of the insulation housing 40 and the delivery device 70 defines the second contact region 88.2.

There are two groups of contacts 90 in each contact region 88.1, 88.2. A first group defines holding contacts 92, and a second group defines transport contacts 94. In both contact regions 88.1, 88.2, the holding contacts 92 and the transport contacts 94 are each arranged radially around the process housing 18 in the circumferential direction, with two holding contacts 92 and two transport contacts 94 being visible in each case due to the section. In practice, two or four and optionally six holding contacts 92 and two or four and optionally six transport contacts 94 are preferably present. The holding contacts 92 and transport contacts 94 are preferably designed such that they lie flat against the outer lateral surface surface of the housing segments 24 with a contact region (not separately denoted by a reference symbol) when they contact a housing segment 24. In the case of an outer lateral surface of the housing segments 24 with a circular cross section, the contact region has an arc-shaped profile.

Both the holding contacts 92 and the transport contacts 94 can be moved with the aid of a motor using a drive system 96; for the sake of clarity, none of the components required for the movement, such as motors, guides, or the like, are specifically shown.

The drive system 96 is configured such that the electrical contacts 90—i.e., both the holding contacts 92 and the transport contacts 94—can be moved in the radial direction toward or away from the process housing 18 and are thereby either brought into a contact position in contact with the process housing 18 or released from the process housing 18 in a release position.

In addition, the drive system 96 is configured such that the transport contacts 94 can be moved in both directions of the process chamber axis 22 between an upper position and a lower position toward or away from the insulation housing 40.

In both contact regions 88.1, 88.2, the transport contacts 94 are arranged on the side of the holding contacts 92 remote from the core process section 50 as viewed in the direction of the process chamber axis 22.

The holding contacts 92 and the transport contacts 94 are cooled by means of a contact cooling system 98. In the present exemplary embodiment, the contact cooling system 98 is embodied as a fluid cooling system 100, in particular as a water cooling system, for which purpose the holding contacts 92 and the transport contacts 94 have internal fluid channels which are only generally indicated by reference numeral 102 and through which a cooling fluid can flow.

In the present exemplary embodiment, the fluid channels 102 of the holding contacts 92 and the transport contacts 94 are fluidically connected by external fluid lines 104. An inflow arrow 106 and an outflow arrow 108 in FIG. 1 illustrate that a cooling fluid is supplied, for example, to a first holding contact 92 and flows therethrough, then travels via a fluid line to a transport contact 94 and flows therethrough, then flows through the remaining contacts 92, 94, in order to finally flow through a holding contact 92 again and be discharged from there. Other flow sequences are possible.

In the exemplary embodiment shown in FIG. 1, the delivery device 70 comprises a movement system 110 for the two discharge conveyors 72.1 and 72.2 that are present here. The movement system 110 is configured such that the two discharge conveyors 72.1 and 72.2 can each be moved parallel and perpendicular to the process chamber axis 22. The two discharge conveyors 72.1, 72.2 can move independently of each other. Also for the sake of clarity, none of the components that are required for the movement, such as motors, guides, or the like, are specifically shown in connection with the movement system 110.

During operation, the process housing 18 wears out and must be replaced after a certain service life. By virtue of the segmentation and the structure of the process housing 18 by the housing segments 24, the process housing 18 in the furnace 14 can be replaced segment by segment during operation. The housing segments 24 are exchanged as they circulate.

An exchange of housing segments 24 is basically understood to mean that a housing segment 24 is removed from the process housing 18 and, in exchange, a housing segment 24 is added to the process housing 18.

In particular, the furnace 14 does not have to be shut down for this purpose and heated up again after the replacement of a housing segment 24.

The housing segments 24 of the process housing 18 can be moved for this purpose through the core process section 50 of the device 10, for which purpose the device 10 comprises a transport system 112. In the present exemplary embodiment, the transport system 112 comprises as its main components the holding contacts 92 and the transport contacts 94 with their associated drive system 96. As will be explained further below, the transport system 112 and the movement system 110 of the delivery device 70 work together with coordinated movements of the housing segments 24 on the one hand and of the discharge conveyors 72.1, 72.2 on the other hand.

In the first exemplary embodiment of the furnace 14 according to FIG. 1, such an exchange takes place after a certain service life which is defined for the housing segments 24. In this case, a worn housing segment 24 is removed from the process housing 18 in the outlet zone 60 and a new housing segment 24, which usually has not yet had any service life, is added to the process housing 18 in the inlet zone 58, as will be explained below with reference to FIGS. 3a, 3b.

FIG. 2 shows a second exemplary embodiment of the device 10, in which components and parts that functionally correspond to those of the device 10 in the first exemplary embodiment according to FIG. 1 bear the same reference numerals. What has been said thus far applies accordingly.

In this device 10, the process housing 18 has a different design than in the device 10 according to FIG. 1. Specifically, the housing segments 24 are not embodied as housing sleeves 30 that are open on both end faces, but as material containers 114 which also have a circumferential housing shell wall 26 but also comprise a bottom wall 116. If necessary, the bottom wall 116 can be detachable, but in practice the bottom wall 116 is connected to the housing shell wall 26, possibly also in one piece. In the present exemplary embodiment, the material containers 114 are embodied in this form as material crucibles.

The dimensions and geometries of the material containers 114 can vary relatively widely. In practice, the housing shell wall 26 of such material containers 114 can have a wall thickness between 7 mm and 18 mm, and the bottom wall 116 can have a thickness of from 10 mm to 45 mm. Various crucible designs have proven suitable. In particular, a material container 114 can also be embodied as a long crucible and, in one specific exemplary embodiment, have, for example, a length of 3000 mm, a width of only 213 mm, and a height of 330 mm. In that case, the wall thickness is preferably 15 mm, and the bottom wall 116 preferably has a thickness of 40 mm. FIG. 2 illustrates a section of a long crucible transverse to its longitudinal extension.

In designs with a rather square bottom wall 116 or base area, good results were able to be achieved with dimensions of length and width of 500 mm each and a height of 100 mm, a division into four quadrant sub-spaces being provided by internal partition walls. A relatively thin base wall 116 with a thickness of 15 mm can be used here. In an alternative approach, a matrix of 5×5 sub-spaces was constructed using internal partition walls, for example, and a height of 1,000 mm was achieved with the same base area. In that case, the bottom wall should have a thickness of 30 m.

It should be emphasized that these dimensions and geometries—as with the housing sleeves 30 above—are only intended to illustrate the variability of the dimensions and geometries of the housing segments 24.

In such a material container 114, the associated process chamber section 28 is thus delimited both by the surrounding housing wall 26 and by the bottom wall 116. In the case of two housing segments 24 that are immediately adjacent along the process chamber axis 22, the process chamber sections 28 are thus separated from one another by the bottom wall 116 of the upper of the two housing segments 24. In a refinement that is not specifically shown, a material container 114 can additionally comprise a detachable lid.

The core process chamber 52 of the process housing 18 is defined by the process chamber sections 28 of those material containers 114 which are located in the core process section 50 of the furnace 14.

In this exemplary embodiment, the material 12 is conveyed through the core process section 50 by transporting the housing segments 24—here the material containers 114—through the core process section 50 by means of the transport system 112. In this sense, the second exemplary embodiment of the device 10 also generally includes the conveyor system 80, which is set up in such a way that the material 12 can be conveyed through the core process section 50; its function is fulfilled by the transport system 112.

Compared to the first exemplary embodiment according to FIG. 1, the use of material containers prevents the formation of ratholes or arches in the process housing 18, as is generally known with bulk materials. The material 12 and the material partially converted to graphite 16 in the process housing 18 is to be understood in this sense as bulk material in the first exemplary embodiment according to FIG. 1 and can form such rathole and arch structures, which can hinder the uniform passage of the material through the process chamber 20.

In the exemplary embodiment according to FIG. 2, the inlet zone 58 of the device 10 is arranged vertically below, and the outlet zone 60 of the device 10 is arranged vertically above.

In the second exemplary embodiment according to FIG. 2, the transport system 112 also comprises the holding contacts 92 and the transport contacts 94 with their associated drive system 96 as main components. In order to secure the material containers 114 in the downward direction, the transport system 112 comprises a support device 118 that is arranged vertically below in the inlet zone 58, which can be embodied, for example, as a cylinder unit 120 with a support element that can be moved in the vertical direction between a low position and a high position, here in the form of a support plate 122, as illustrated in FIG. 2.

In the inlet zone 58 is located a filling station 124 with which an empty material container 114 can be filled with graphitizable material 12. In addition, in the outlet zone 60 is located an emptying station 126 with which obtained material, i.e., graphite 16, can be removed from a material container 114 after the treatment. The filling station 124 and the emptying station 126 are only indicated very schematically; suitable lock designs have been implemented and corresponding housing structures are present in order to prevent contamination of the furnace atmosphere with foreign atmosphere.

Suitable cooling zones ensure that the material in the outlet zone 60 is brought to a temperature of below 1,500° C.

In this exemplary embodiment, the housing segments 24 are also replaced as they circulate, which, however, does not only take place after a certain service life but is coordinated with the residence time of the material 12 in the furnace 14. However, a worn-out material container 114 is simply removed from the cycle at the appropriate time and replaced by a new material container 114.

The operation of the furnace 14 according to the first exemplary embodiment of FIG. 1 will now be explained with reference to FIGS. 3a and 3b; for the sake of simplicity, only the reference numerals mentioned below are assigned.

Before initial startup, the process chamber 20 or the process chamber atmosphere prevailing therein must first be freed of oxygen and moisture, in particular from existing air. For this purpose, the process chamber 20 is flushed with the inert gas, and the annular chamber 46 as well as the insulation annular chamber 48 are flushed with protective gas.

Graphitizable material 12 is fed to the process chamber 20 by means of the feed conveyor 64, and a column of material builds up in the core process chamber 52 in the core process section 50 of the furnace 14. When the discharge conveyor 72.1 is subsequently activated, it initially conveys incompletely converted material out of the process chamber 22 until graphite 16 obtained in the core process chamber 52 reaches the discharge conveyor 72.1.

During the ongoing graphitization process, graphitizable material 12 is continuously fed into the process chamber 20 by the feed conveyor 64, and graphite 16 obtained therefrom is first continuously removed from the process chamber 20 by the discharge conveyor 72.1. Here, as much volume of graphitizable material 12 is supplied per unit of time, for example per minute, as the volume of graphite 16 is removed per unit of time, i.e., optionally per minute, so that the fill level in the process housing 18 remains largely constant. The furnace 10 is therefore operated continuously in relation to the material level.

In one refinement, the furnace 10 is operated intermittently in relation to the material level. In that case, with simultaneous supply and removal, graphitizable material 12 is continuously supplied to the process chamber 20 with the feed conveyor 64, and graphite 16 obtained therefrom is simultaneously continuously removed from the process chamber 22 with the discharge conveyor 72.1 when a material exchange process is carried out in which a certain volume of graphite 16 is removed and, in exchange for this, a corresponding volume of graphitizable material 12 is added.

In any case, the conveying speeds of the feed conveyor 64 and the discharge conveyor 72.1 are set during continuous furnace operation such that the residence time of the graphitizable material 12 in the core process chamber 52 at about 3,000° C. is from 30 minutes to 10 hours, in particular from about 2 to 3 hours. Graphite 16 may already be present in a lower region of the core process chamber 52 which is no longer mixed with graphitizable material. At a temperature in the core process chamber 52 of about 2,700° C., the residence time of the graphitizable material 12 can be from about 10 to 20 hours.

As explained above, the housing segments 24 can only be used for a limited time and are subject to wear. Their replacement now works as follows:

Phase A in FIG. 3a is used as the initial configuration for the sake of example. The holding contacts 92 contact the process housing 18 in their contact position. When the heating device 84 is activated, which is no longer shown separately in FIG. 3a, the housing segments 24 and hence the process housing 18 heat up due to the electrical resistance thereof. The transport contacts 94 are released from the process housing 18 in their release position, and each assume their upper position.

As was described above, the first discharge conveyor 72.1 is connected with its inlet side 74 to the outlet housing segment 24.2. In the vertical direction, the device 10 specifies a standard operating position for the outlet housing segment 24.2 in which the outlet housing segment 24.2 is also located in phase A. The second discharge conveyor 72.2 is arranged vertically next to the outlet housing segment 24.2—to the right of it in the example shown here.

In addition to the discharge conveyor 72.1, the discharge conveyor 72.2 is now activated. The discharge conveyor 72.1 and the discharge conveyor 72.2 are then moved to the left by means of the movement device 110 together with the vertically lowermost housing segment 24.2.

The second discharge conveyor 72.2 slides under the housing segment which is denoted by 24.3 in phase A and is still located above the outlet housing segment 24.2.

In an intermediate phase (not shown), graphite 16 consequently passes from the outlet housing segment 24.2 into the first discharge conveyor 72.1 and from the aforementioned housing segment 24.3 into the second discharge conveyor 72.2 until phase B according to FIG. 3a has been reached. In this phase B, the second discharge conveyor 72.2 is now fully connected to the housing segment 24.3, which thus takes over the function of the outlet housing segment 24.2. The former replacement housing segment removed from the process housing 18 now bears reference numeral 24.4.

The housing segment 24.4 removed from the process housing 18 is now removed from the process. The transport contacts 94 are moved radially into their contact position in their respective upper position. The holding contacts 92, on the other hand, are released in the radial direction from the process housing 18 and moved into their release position. This configuration is shown by phase C in FIG. 3a.

The feed conveyor 64 is now deactivated and, with the aid of the drive system 96 and the movement system 110, both the transport contacts 94 and the second discharge conveyor 72.2 are moved downward in a vertical direction until the now defined outlet housing segment 24.2 reaches its standard operating position; this is shown by phase D in FIG. 3b. As can be seen there, there is now a gap between the previous inlet housing segment 24.1 and the feed conveyor 64.

A replacement housing segment, denoted by 24.5, is now moved into this gap until it is connected to the outlet side 68 of the feed conveyor 64 on the one hand and to the adjacent, previous inlet housing segment 24.1 on the other hand; this function is now taken over by the replacement housing segment 24.5. The feed conveyor 64 is now activated again.

This is shown by phase E in FIG. 3b. As can also be seen there, starting from phase D, the first discharge conveyor 72.1 has been additionally moved upward in a vertical direction until it is located next to—here now to the left of—the current outlet housing segment 24.2. In addition, the holding contacts 92 have been moved back to their contact position, and the transport contacts 94 have been moved back to their release position and to their upper position.

Phase E therefore corresponds to phase A, with the difference that the positions and functions of the discharge conveyors 72.1 and 72.2 have been swapped. It is now the second discharge conveyor 72.2 that works together with the outlet housing segment 24.2.

If the currently present outlet housing segment 24.2 is to be replaced, the procedure is as described above, with the difference that the first discharge conveyor 72.1 is now moved to the right together with the outlet housing segment 24.2, and then the second discharge conveyor 72.2 is moved to the right and upward, and the remaining movements are carried out until the configuration according to phase A in FIG. 3a has been reached again.

Each exchange of a housing segment 24 defines an exchange cycle, and the two discharge conveyors 72.1 and 72.2 therefore always perform a kind of back and forth movement during two consecutive such exchange cycles.

By removing and inserting the housing segments 24 at the opposite ends 18a and 18b of the process housing 18 (see FIG. 1) as they circulate, it is ensured that all housing segments 24 are or can be operated for the same service period by performing the replacement cycles after the same period of time.

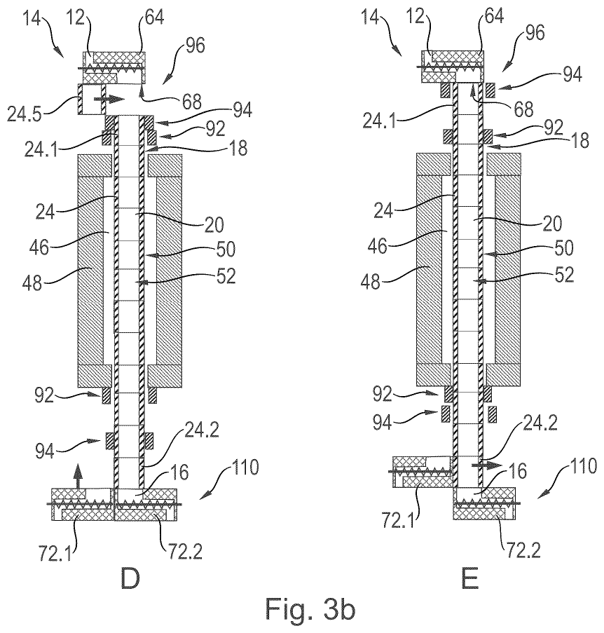

The operation of the furnace 14 according to the second exemplary embodiment of FIG. 2 will now be explained with reference to FIGS. 4a and 4b; for the sake of simplicity, only the reference numerals mentioned below are assigned.

In the second exemplary embodiment of the furnace 14 according to FIG. 2 as well, during the replacement of housing segments 24, a housing segment 24—here a material container 114—is removed in the outlet zone 60, and a new housing segment 24—i.e., a new material container 114—is fed into the inlet zone 58. As mentioned, however, the inlet zone 58 is located at the bottom.

Phase A in FIG. 4a is used as the initial configuration for the sake of example.

All material containers 114 are filled with material there. The holding contacts 92 contact the process housing 18 in their contact position. When the heating device 84 is activated, which is also not shown in FIGS. 4a and 4b, the housing segments 24 and hence the process housing 18 heat up due to the electrical resistance thereof. The support plate 122 of the support device 118 assumes its upper position and supports from below against the inlet housing segment 24.1.

The transport contacts 94 are released from the process housing 18 in their release position, and each assume their lower position here. The lower position of the transport contacts in the inlet zone 58 is adjusted such that they can grip the inlet housing segment 24.1 there—i.e., the lower terminal housing segment of the process housing 18.

This is now carried out, and the transport contacts 94 are moved radially into their contact position in their respective lower position. In the inlet zone 58, the transport contacts 94 thus hold the inlet housing segment 24.1 and thus also hold and support the housing segments 24 located above it. The holding contacts 92, on the other hand, are released in the radial direction from the process housing 18 and moved into their release position.

A material container denoted by 114a is filled with material 12 by means of the filling station 124 under an inert gas atmosphere. The support plate 122 of the support device 118 is moved to its lowest position and releases a gap and a space for a material container 114.

The current configuration is shown by phase B in FIG. 4a.

As illustrated by phase C in FIG. 4a, the material container 114a is now moved by means of the transport system 112 into this gap to the space below the previous inlet housing segment 24.1 and added to the process housing 18, so that this material container 114a now defines the inlet housing segment 24.1 accordingly by definition. At the same time, the material container in the outlet zone 60, now denoted by 114b, which provides the outlet housing segment 24.2, is moved to the emptying station 126 and thus removed from the process housing 18.

A configuration according to phase D in FIG. 4b is now available.

Thereafter, only the transport contacts 94 are moved upward to their upper position, and the support plate 122 of the support device 118 is moved upward to its high position, so that the process housing 18 moves upward by one housing segment space as shown by phase E.

Finally, the holding contacts 92 are moved back to their contact position, and the transport contacts 94 are moved to their release position in the lower position, so that one cycle is carried out and a configuration corresponding to phase A in FIG. 3a is again achieved.

FIGS. 5 to 10 show a first exemplary embodiment of a conveying device, denoted overall by 128, for conveying material 130, which is in particular the material 12 which is fed to the graphitization furnace 14 or the graphite 16 that is obtained by means of the furnace 14. In the first exemplary embodiment of the graphitization furnace 14 shown in FIG. 1, the conveying device 128 according to FIGS. 5 to 13 can be used both as a feed conveyor 64 and as a discharge conveyor 72.1 and/or 72.2. Above all, the conveying device 128 is designed to convey hot material 130, which can have a temperature of 1,500° C., and is used in particular for conveying thermally or thermo-chemically treated material.

The conveying device 128 comprises at least one housing 132 with a first passage 134 and a second passage 136. In the present exemplary embodiment, the first passage 134 is defined as the material inlet and the second passage 136 as the material outlet and will be referred to as such in the following. However, the conveying device 128 can also be used in such a way that the first passage 134 serves as a material outlet and the second passage 136 serves as a material inlet; this is illustrated, for example, by the feed conveyor 64 in the device 10 in FIG. 1.

From the material inlet 134 to the material outlet 136, the conveying device 128 defines a conveyance path 138 for the material 130 that is to be conveyed. The conveying device 128 comprises a conveying device 140 by means of which the material 130 is conveyed from the material inlet 134 to the material outlet 136 along the conveyance path 138.

The material inlet 134 and the material outlet 136 are arranged such that the material 130, during operation of the conveying device 128, both enters the conveyance path 138 through the material inlet 134 due to gravity and leaves the conveyance path 138 through the material outlet 136 due to gravity. In practice, when the conveying device 128 is in operation, the material inlet 134 points upward and the material outlet 136 points downward.

Along the conveyance path 138, surfaces that come into contact with the material 130 that is to be conveyed are provided, at least in some areas, by a material 142 that is a graphite material or a material with graphite-like properties. Hard graphite is particularly suitable as a graphite material. Materials with graphite-like properties can, for example, be carbon fiber-reinforced carbon materials, so-called carbon fiber carbon composite materials or CFC materials for short, or carbide materials such as tungsten carbide.

The parts and components of the conveying device 128 described below—in both exemplary embodiments of the conveying device 128—which have surfaces that come into contact with the material 130, are as such made entirely from the material 142. In a refinement that is not specifically shown, some or all of these parts and components may also be equipped only with a corresponding outer layer made of material 142.

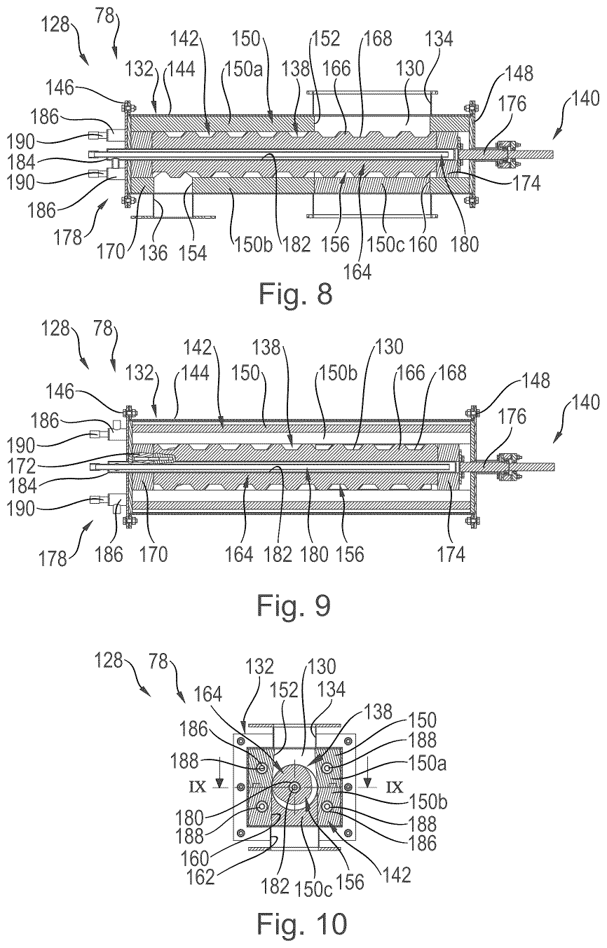

In FIGS. 8 to 13, reference numeral 142 is given only as an example.

The housing 132 is made of metal and preferably of sheet steel and comprises a circumferential housing shell 144 to whose opposite end faces a connection plate 146 and a bearing plate 148 are fastened.

The housing shell 142 is lined with a protective shell 150 made of material 142. The protective casing 150 has a first passage 152 and a second passage 154 whose the geometry and arrangement are respectively complementary to the first passage 134 (material inlet) and the second passage 136 (material outlet) of the housing 132. In association with the material inlet 134 and the material outlet 136, the passage openings 152 and 154 are therefore an inlet opening 152 and an outlet opening 154.

The conveyance path 138 of the conveying device 128 comprises a conveying chamber 156 which is delimited by the inner circumferential surface of the protective casing 150. The conveyance path 138 also includes at least the path through the passages 152 in the protective casing 150.

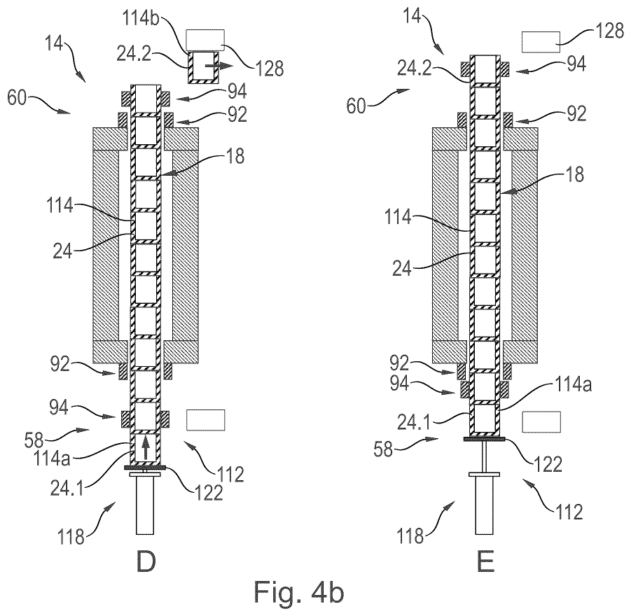

The conveying chamber 156 defines a longitudinal axis 158 of the conveying device 128, which only bears a reference numeral in FIG. 6 based on the sectional line IX-IX. In the present exemplary embodiment, the conveying chamber 156 is cylindrical with a circular cross section. The material inlet 134 and the material outlet 136 are arranged so as to be offset in the direction of this longitudinal axis 158 and not tooverlap in the direction perpendicular to the longitudinal axis 158.

As can be seen in FIGS. 8 to 10, the protective casing 150 is made up of multiple parts and comprises a first casing part 150a facing the material inlet 134, which accordingly has the inlet passage 152, and a second casing part 150b facing the material outlet 136, which accordingly has the outlet passage 154. In addition, in the present exemplary embodiment there is also a third casing part 150c which is complementarily seated in a passage opening 160 of the protective casing 150 and seals the same, which protective casing 150, in turn, is complementary in its geometry and arrangement to a third passage 162 of the housing 132, which will be discussed again below.

If this third passage 162 of the housing is not present, the protective casing 150 can also be formed without the passage opening 160 and can be continuous there. In one refinement, the protective casing 150 can also be made entirely of one piece and, accordingly, provide a one-piece outer sleeve with the passage openings 152 and 154 and, optionally, the passage opening 160.

FIGS. 8 to 10 show sections of the conveying device 128, which is embodied as a screw conveyor 78.

In order to convey the material 130 from the material inlet 134 to the material outlet 136 of the conveying device 128, the conveying device 140 comprises a screw conveyor 164 as a conveying element which is arranged coaxially with the longitudinal axis 158 in the conveying chamber 156. The screw conveyor 164 has a threaded web 166, so that a groove-shaped conveyor path 168 is formed.

The screw conveyor 164 is characterized by the following parameters and dimensions:
Web width at the passage inlet (outside): from 10 mm to 50 mm, in particular from 20 mm to 30 mm;
Web width at the passage base: from 20 mm to 100 mm, in particular from 40 mm to 60 mm;
Passage depth: from 2 mm to 30 mm, in particular from 10 mm to 20 mm;
Passage width at the passage base: from 10 mm to 50 mm, in particular from 25 mm to 40 mm; Core diameter: from 50 mm to 300 mm, in particular from 80 mm to 100 mm.

The screw diameter is the sum of the core diameter and the passage depth. The passage slope at the passage base is the sum of the passage width and the web width.

In the exemplary embodiment shown here, the thread web 166 tapers in a radially outward direction, and the conveyor path 168 tapers in a radially inward direction. In one refinement, the thread web 166 or the conveyor channel 168 can also have a constant cross section in the radial direction; in that case, the web width at the channel inlet and at the channel base is identical.

The connecting plate 146 of the housing 132 rotatably supports a bearing block 170. The screw conveyor 164 is connected at a first end to the bearing block 170 by means of a rotationally fixed connection 172, which can be seen in FIG. 9 on the basis of a modified section in the form of a connecting screw.

At the opposite end, the screw conveyor 164 is also connected in a rotationally fixed manner to a coupling block 174 which, in turn, is coupled in a rotationally fixed manner to a drive shaft 176 which is rotatably mounted by the bearing plate 148 and extends outwardly therethrough. There, the drive shaft 176 is connected to a drive system (not specifically shown) and can therefore be rotated. Depending on the direction of rotation of the drive shaft 176 and the screw conveyor 164, the material 130 is conveyed from the first passage 134 to the second passage 136 or in the opposite direction. In the latter case, the second passage 136 serves as the material inlet and the first passage 134 serves as the material outlet.

The bearing block 170, the coupling block 174, and the drive shaft 176 are also made of the material 142, but other, appropriately heat-resistant materials can also be considered.

The screw conveyor 164 defines the transport direction of the material 130 parallel to the longitudinal axis 158 of the conveying chamber 156.

In practice, the conveying chamber 156 has a length of 50 cm, with the greatest distance being measured between the mutually remote edges of the material inlet 134 and material outlet 136. However, other lengths of the conveyor chamber and, analogously, other lengths of the screw conveyor 164 are also possible, which can be up to 600 cm.

The conveying device 128 comprises a cooling system 178 with which the screw conveyor 164 and the housing 132 can be cooled. The latter is done by cooling the protective casing 150.

For cooling the screw conveyor 164, a coaxial cooling pipe 180 is provided in the screw conveyor 164 which, in the present exemplary embodiment, is provided coaxially with the longitudinal axis of the screw conveyor 164. For this purpose, the bearing block 170 and the screw conveyor 164 have coaxial through-bores and the coupling block 174 has a coaxial blind hole, which together form a blind channel 182 into which the coaxial cooling pipe 180 is inserted at whose free end there is a connection unit 184 for the inflow and outflow of a cooling fluid which protrudes from the connection plate 146. A coaxial cooling tube is double-walled, with an inner tube and a ring tube surrounding it, as illustrated in the figures. It is characterized in that the connections for the inflow and outflow of a cooling fluid are arranged at one and the same end of the coaxial cooling tube. At the opposite end, the inner tube and the ring tube are fluidically connected. Incoming and outgoing cooling fluid is thus guided in countercurrent.

In one refinement, a blind channel can also be formed in the screw conveyor 164, so that the coaxial cooling pipe 180 ends before the coupling block 174.

For cooling, additional coaxial cooling tubes 186 are provided in the protective casing 150. For this purpose, the protective casing 150 has blind channels 188 parallel to the blind channel 182 which can only be seen in the section according to FIG. 10. In each of these blind channels 188, one of the coaxial cooling tubes 186 is inserted at whose free ends a connection unit 190 is provided which is also accessible on the connection plate 146. The connection plate 146 thus defines a connection terminal of the conveying device 128 at which the connection units 184, 190 of the existing coaxial cooling pipes 180, 186 are accessible from the outside.

In the present exemplary embodiment, four coaxial cooling tubes 186 are provided in the protective casing 150. For the sake of clarity, only two coaxial cooling tubes 186 with connection 190 are provided with a reference symbol in the figures.

Depending on the dimensions and geometry of the housing 136 and the protective casing 150, more or fewer coaxial cooling tubes

In a refinement that is not specifically shown, the protective casing 150 can also have through-channels, and the inflow connection and the outflow connection for cooling fluid can be present on the opposite sides and hence on the connection plate 146 on the one hand and on the bearing plate 148 on the other.

FIGS. 11 to 13 show a second exemplary embodiment of the conveying device 128, which is embodied as a roller conveyor 82 in which the housing 132 with the material passages 134, 136 and 162 is identical.

In this exemplary embodiment, however, the first passage 134 of the housing 132 serves as the material inlet and the third passage 162 as the material outlet and are also referred to as such below. The conveyance path 138 is thus defined from the material inlet 134 to the material outlet 162, whereby this material inlet 134 and this material outlet 162 overlap in the direction perpendicular to the longitudinal axis 158.

In the protective casing 150, the passage opening 160 remains open in this case and is defined as the outlet opening; the casing part 150c is not used.

The conveying device 140 now comprises a conveying roller 192 as a conveying element which forms axially parallel conveying grooves 194 on its outer lateral surface and which is arranged coaxially with the longitudinal axis 158 in the conveying chamber 156. The conveying grooves 194 can also have a different profile but extend at least in the direction of the longitudinal axis 158. Nor do the conveying grooves 192 have to run parallel to each other.

The conveyor roller 192 is characterized by the following parameters and dimensions:
Groove width at the groove inlet (outside): from 10 mm to 100 mm, in particular from 15 mm to 25 mm;
Groove width at the groove base: from 5 mm to 95 mm, in particular from 10 mm to 20 mm; Groove depth: from 2 mm to 30 mm, in particular from 3 mm to 10 mm;
Spacing between the grooves in the circumferential direction: from 5 mm to 30 mm, in particular from 10 mm to 20 mm;
Core diameter: from 50 mm to 1000 mm, in particular from 80 mm to 200 mm.

The roller diameter is the sum of the core diameter and the groove depth.

The conveyor roller 192 defines the transport direction of the material 130 perpendicular to the longitudinal axis 158 of the conveying chamber 156.

The coaxial cooling pipe 180 is present in the conveyor roller 192. The conveyor roller 192 has a coaxial blind hole 196 into which the coaxial cooling pipe 180 of the cooling system 178 is inserted. The conveyor roller 192 is coupled to the drive shaft 176 at the end remote from the blind hole 194.

In refinements that are not specifically shown, the conveying device 140 can also comprise two parallel screw conveyors 164 or two parallel conveyor rollers 192.

If the conveying device 128, in particular in the form of the screw conveyor 78, is used in the device 10 according to FIG. 1 as a discharge conveyor 72.1, 72.2, it is possible to cool the graphite 16 obtained at a temperature of about 3,000° C. to temperatures of below 100° C. during discharge.

In particular, the relatively small passage depth of the screw conveyor 168 or the relatively small groove depth of the conveyor roller 192 contribute to the fact that the material located there during the conveying process can be effectively cooled due to the contact with the cooled screw conveyor 168 or conveyor roller 192 and the surrounding cooled protective casing 150 on its way from the material inlet 134 to the material outlet 136 or 162.

What is claimed is:

1. A conveying device for conveying thermally or thermo-chemically treated material having a temperature of 1,500° C. to 3,200° C., comprising:
a) a housing having a material inlet and a material outlet;
b) a conveying device by means of which the thermally or thermo-chemically treated material can be conveyed from the material inlet-to the material outlet along a conveyance path;
wherein,
c) along the conveyance path, those surfaces which come into contact with the thermally or thermo-chemically treated material-that is to be conveyed are provided, at least in some portions, by a second material-which is a graphite material or a material with graphite-like properties.

2. The conveying device according to claim 1, wherein all surfaces which come into contact with the thermally or thermo-chemically treated material that is to be conveyed along the conveyance path are provided by the second material.

3. The conveying device according to claim 1, the second material is hard graphite and/or a CFC material and/or a carbide material.

4. The conveying device according to claim 1, wherein the conveyance path comprises a conveying chamber which defines a longitudinal axis and in which a conveying element is arranged.

5. The conveying device according to claim 4, wherein the conveying element is a screw conveyor-which is arranged parallel to the longitudinal axis of the conveying chamber and has a threaded web, thereby forming a conveyance path.

6. The conveying device according to claim 5, wherein the screw conveyor has one or more or all of the following parameters:
a) a web width at the passage inlet of 10 mm to 50 mm;
b) a web width at the passage base of from 20 mm to 100 mm;
c) a passage depth of from 2 mm to 30 mm;
d) a passage width at the passage base of from 10 mm to 50 mm; and
e) a core diameter of from 50 mm to 300 mm.

7. The conveying device according to claim 4, wherein the conveying element is a conveying roller which has conveying grooves on its outer lateral surface, in particular running parallel to the longitudinal axis of the conveying chamber.

8. The conveying device according to claim 7, wherein the conveyor roller has one or more or all of the following parameters:
a) a groove width at the groove inlet of from 10 mm to 100 mm;
b) a groove width at the groove base of from 5 mm to 95 mm;
c) a groove depth of from 2 mm to 30 mm;
d) a spacing of the conveying grooves-in the circumferential direction: from 5 mm to 30 mm; and
e) a core diameter of from 50 mm to 1000 mm.

9. The conveying device according to claim 4, wherein the conveying chamber is delimited by the inner circumferential surface of a protective casing made of the second material.

10. The conveying device according to claim 9, wherein the protective casing is made up of multiple parts.

11. The conveying device according to claim 4, wherein a cooling system is present by means of which the conveying element and/or the protective casing can be cooled.

12. The conveying device according to claim 11, wherein the cooling system comprises one or more coaxial cooling pipes, each of which is arranged in the conveying element and/or in the protective casing.

13. The conveying device according to claim 12, wherein a coaxial cooling pipe is arranged in the conveying element coaxially with the longitudinal axis of the conveying element.

14. The conveying device according to claim 12, wherein the connection units of the existing coaxial cooling pipes are accessible from the outside at a connection terminal.

15. The conveying device according to claim 4, wherein the conveying element is made entirely of the second material.

16. The conveying device according to claim 1, wherein the housing has a first passage, a second passage, and a third passage, of which one passage provides the material inlet and the material outlet, respectively, depending on the conveying element.

17. The conveying device according to claim 6, wherein the screw conveyor has one or more or all of the following parameters:
a) a web width at the passage inlet of 20 mm to 30 mm;
b) a web width at the passage base of 40 mm to 60 mm;
c) a passage depth of 10 mm to 20 mm;
d) a passage width at the passage base of 25 mm to 40 mm; and
e) a core diameter of 80 mm to 100 mm.

18. The conveying device according to claim 8, wherein the conveyor roller has one or more or all of the following parameters:
a) a groove width at the groove inlet of 15 mm to 25 mm;
b) a groove width at the groove base of 10 mm to 20 mm;
c) a groove depth of 3 mm to 10 mm;
d) a spacing of the conveying grooves in the circumferential direction: from 10 mm to 20 mm; and
e) a core diameter of 80 mm to 200 mm.

19. The conveying device according to claim 15, wherein the second material is one or more of hard graphite, CFC material, or carbide material.
